(19) United States
(12) Patent Application Publication
(10) Pub. No.: US 2025/0241252 A1
(43) Pub. Date: Jul. 31, 2025

(54) PLANT PLUG, MANUFACTURING METHOD AND USE THEREOF

(71) Applicants: Maan Intellectual Properties B.V., Raalte (NL); KLASMANN-DEILMANN GMBH, GEESTE (DE)

(72) Inventors: Anna Maria Wouda, Raalte (NL); Bernard Manfred Wehming, Geeste (DE)

(21) Appl. No.: 18/854,771

(22) PCT Filed: Apr. 20, 2023
(86) PCT No.: PCT/EP2023/060279

§ 371 Date: Oct. 7, 2024

(30) Foreign Application Priority Data
Apr. 22, 2022 (NL) 2031666

(51) Int. Cl. A01G 24/46; A01G 24/30

(52) U.S. Cl. CPC A01G 24/46; A01G 24/30

(57) ABSTRACT

A plant plug for germinating, cutting and/or growing plants and/or for tissue culture includes a strip of polymeric fibres, where the fibres are substantially oriented in the plane of the strip and optionally locally mutually bonded to one another, and where the strip is arranged in multiple, vertically arranged layers. In a layer the fibres may be substantially oriented horizontally or vertically. A typical configuration includes a cylinder shaped plant plug. A manufacturing method and various uses of the plant plug are also described.

### CROSS-REFERENCE TO RELATED APPLICATION

This application is the National Stage of International Application No. PCT/EP2023/060279, filed Apr. 20, 2023, which claims the benefit of Netherlands Application No. 2031666, filed Apr. 22, 2022, the contents of which is incorporated by reference herein.

### FIELD OF THE INVENTION

The present invention relates to a plant plug for germinating, cutting and/or growing plants, a method of manufacturing such a plant plug and use thereof.

### BACKGROUND OF THE INVENTION

Plant plugs, also known as rooting plugs, seed plugs or growth plugs, are well known for cultivation of plants, for example for germinating seeds, growing seedlings, cuttings and plants. Typically these plugs are made from a substrate material including organics and/or non-organics and formed into a plug body having a substantially cylindrically shape around a cylinder axis, although other shapes e.g. rectangular blocks are also known. One plug type is comprised of natural substrate material like soil and/or additional nutrients that contribute to cultivation. The materials are held together, e.g. using a suitable adhesive or carrier. Another plug type merely has the main function of providing a stable support for the seed or plant to be grown. Examples of the latter type include plant plugs made from mineral wool.

Now EP172060A2 has disclosed a culture substrate for improving the development of plant organs, such as seedlings, consisting of a cylindrical plug. This plug having a diameter up to approximately 3 cm is formed from a material strip having long fibres carried on a support. The strip is folded on itself to form the cylindrical plug such that the long fibres are disposed radially relative to the axis of the plug. The two end lips of the strip are fastened to each other, for example by sewing, adhesive bonding or welding. For larger diameter plugs thicker strips, multiple coaxially arranged cylindrical strips or a spirally wound strip are contemplated.

Disadvantages of this known plug are, amongst others, that the fibres are to be oriented radially on a support, which is a relative complex process to get the required fibre orientation; that the ends of the cut strip are to be connected mechanically or thermally requiring an additional manufacturing step and equipment; that the highest fibre density of the plug is at the centre thereof where the seedling is to be inserted, offering little space for inserting the seedling and a relative resistance to the development of roots; and that the support may form a barrier to the development of roots from the inside of the plug and uptake of water and nutrients from the outside of the plug.

### BRIEF DESCRIPTION OF THE INVENTION

The present invention aims to overcome those disadvantages at least partly or to provide a usable alternative. In particular the present invention aims to provide a plug having a structure that reduces the relative resistance to root growth. Yet another object of the invention is to improve the free development of roots of seed, tissue culture broth or embryo's, seedlings and plants to be grown, in particular in vertical direction.

Accordingly the present invention provides a plant plug for germinating, cutting and/or growing plants, that comprises a strip, of polymeric fibres, wherein the fibres are substantially oriented in the plane of the strip, and optionally are locally mutually bonded to one another and wherein the strip is arranged in multiple, vertically arranged layers.

The strip may have a woven or a non-woven structure, wherein the fibres are substantially oriented in the plane of the structure. Then fibres do not project from the plane of the strip structure. The configuration of multiple, vertically arranged layers results in little resistance or hindrance to the developing roots in vertical direction between adjacent layers in the plant plug. Therefore root growth in that vertical direction is believed to be promoted. This promoted growth direction is assumed to contribute to the overall growth.

In an embodiment the fibres are substantially oriented in the longitudinal direction of the strip, or the width direction thereof. In an embodiment the fibres are substantially oriented horizontally or vertically in a layer.

The plant plug according to the invention comprises a strip, typically derived e.g. cut from a web of individual filaments, which filaments are oriented mainly in the plane of the web, typically in the same direction, with only a few bonds, if any, such that the web is an open structure of polymeric fibres. In the context of this invention the terms ‘fibre’ and ‘filament’ may be interchangeably used, as the length of the fibres in the strip is not particularly significant. In the web the polymeric fibres are mainly oriented in the longitudinal direction thereof. Preferably the web is manufactured by laying fibres with the aid of air. In such a web the fibres are substantially oriented in the plane of the web, typically the longitudinal direction thereof, and optionally are locally mutually bonded to one another. Thus the web structure and consequently the strip structure may have some local connections, typically at random positions, between the fibres, e.g. by a thermal bond achieved by locally contact of partially molten filaments during manufacturing, such as laying fibres using air wherein inherently some bonding between whirling filaments occurs. Chemical bonding and mechanical bonding are less preferred possibilities. From the web a part is obtained, which part in the context of this application is called a strip. In different words, in the context of this invention the expression ‘web’ is used to define a material area that comprises a multitude of strips. In a strip taken from such a web, fibres are also substantially oriented in the plane of the web, typically the longitudinal direction thereof, and optionally are locally mutually bonded to one another. In other words, the overall fibre orientation in the strip and thus in a layer is parallel to one another. Depending on the dimensions of the strip typically the fibres are oriented in the length direction of the strip or the width direction of the strip. The fibrous strip is arranged in multiple vertically arranged layers. Thus, the plant plug according to the invention has a configuration that comprises a plurality of vertical layers. Typical configurations of plant plugs according to the invention include a cylinder of spirally wound layers and a block of layers in a zigzag pattern. In the upright plug the fibres are substantially oriented horizontally or vertically, depending on the manner how the strip is arranged in vertical layers, as will be explained in more detail hereinafter.

Generally, adjacent layers are not bonded to one another, although some entanglement of fibre ends in a layer, if present, with an adjacent layer may occur. As there are little connections or no connections at all between adjacent layers that are vertically arranged in the plug, there is little resistance or hindrance to the developing roots in vertical direction between adjacent layers in the plant plug. Therefore root growth in that direction is believed to be promoted. This promoted growth direction is assumed to contribute to the overall growth of the seed, seedling, cutting or plant, as the developing roots can reach the water and nutrients contained therein that are typically presented at the bottom of the plant plug. The open structure in the layers themselves and the absence of a support or back sheet in the strip also allow root growth in horizontal direction, e.g. radial direction of a cylindric plant plug. Thus the plug according to the invention has a very open fibrous structure that allows almost resistless growth, which is beneficial for culturing seeds, seedlings and the like.

In an embodiment of the plant plug according to the invention the strip is wound onto itself in multiple layers into a cylinder shape. In a further embodiment thereof the web itself is directly rolled onto itself more than one time to obtain a spirally wound web. Once the desired diameter is achieved the web is cut. The thus spirally wound strip cut from the web is the plant plug. Thus in cross section of this embodiment of the plant plug according to the invention there is more than one layer. In cross-section of the plant plug the fibres extend in circumferential direction. In other words, the fibres are mainly oriented from the centre of the plug in a spiral to the outermost layer. In another embodiment thereof, e.g. in case of a relatively wide web, a strip is cut from the web. Then the strip may be wound onto itself either in the longitudinal direction of the fibres like the embodiment wherein the web is directly wound onto itself, thereby similarly obtaining a plant plug having multiple vertically arranged layers, wherein in cross-section of the plant plug the fibres extend horizontally in circumferential direction. The strip as cut from the web may also be wound onto itself in the width direction of the web, thereby obtaining a plant plug having multiple vertically arranged layers wherein the fibres mainly extend in the vertical direction of the plant plug.

In another embodiment of the plant plug according to the invention the strip is arranged in a zigzag configuration. The strip may be produced by folding a web onto itself into multiple layers thereby forming a stack of horizontal layers and after cutting turning the stack 90°, such that the layers are oriented vertically and the fibres in a layer are oriented mainly in horizontal direction. Again from a relatively wide web a strip can be cut and folded either in the fibre orientation thereby obtaining a plant plug, wherein in a layer the fibres are oriented mainly in horizontal direction, either in cross direction to the fibre orientation thereby obtaining a plant plug, wherein in a layer the fibres are oriented mainly in vertical direction.

In all embodiments the “voids” between adjacent layers might be considered channels, wherein the root development in vertical direction can occur preferentially.

A free end of the strip in the outermost wound or stacked layer may be connected to an adjacent inner layer by entanglement of the fibres ends of the outermost layer into the adjacent inner layer. If necessary in view of dimensional stability of the cylinder shape of the plug, fibres at the free end of the outermost wound layer may be bonded, e.g. thermally bonded by local heating, to fibres in the adjacent inner layer. Similarly in a zigzag configuration as outlined above fibres at one or both free ends of the strip may be bonded to fibres of an adjacent inner layer of the stack of layers. If considered appropriate the folds in the zig zag configuration may be reinforced by bonding, such as thermal bonding, to retain the plug shape. Typically the block of zigzagged layers has a rectangular cross-section.

Depending on the dimensions of the strip (and where appropriate the web itself), number of layers and tension during winding of the strip or web to shape a cylindric plug, the plug may have a central void, wherein a seed, seedling, cutting or plant to be grown can be inserted easily. The void may be filled with an appropriate amount of nutritional substrate material.

However, typically the plant plug functions as a support only without buffer or storage capacity of the fibres for water and nutrients. Then appropriate addition of nutrients and water can be easily controlled due to the open structure of the plug,

The weight and density of the web and consequently those of the strip can be set during manufacturing thereof. Typically the area weight is in the range of 15-150 g/m², such as 15-100 g/m², preferably in the range of 25-100 g/m², more preferably in the range of 50-75 g/m², such as 55-65 g/m². Typically the density of the plug is in the range of 0.020-0.100 g/cm³, preferably in the range of 0.025-0.075 g/cm³, more preferably in the range of 0.030-0.065 g/cm³. Typically the dimensions of the strip and if applicable the web, number of layers and density will be selected and set depending on the type of plants to be grown, as well as the type of carrier or support, such as a (seed) tray having a plurality of recesses, wherein the plant plugs can be inserted or a gutter or floater system, wherein the plant plugs as such are arranged. For example, a suitable density for plugs for growing crops, like lettuce is in the range of 0.025-0.065 g/cm³. Other plants may have a different optimal density. Generally, the fibre thickness of the individual fibres in the structure is in the range of 10-100 μm, such as in the range of 15-75 μm, for example in the range of 20-50 μm. Usually in the web the whirly or wavy fibres may have some overlap, such that web thickness itself is typically several times, such as three to ten times, the fibre thickness. As the strip is generally obtained from the web, the strip thickness and thus the thickness of a layer is similar to the web thickness.

The web is comprised of a polymeric material, that can be processed into fibres. The material from which the web is made, preferably comprises a biodegradable polymer, such as polyesters, advantageously a biobased, biodegradable polymer. In the context of this application ‘biodegradable” includes an industrially compostable material, such as a material that complies with the EN13432 standard. E.g. the polymeric composition may be comprised partly (such as more than 60 wt. %) of biobased material derived from biomass, e.g. determined in accordance with EN16785-1, while the remainder is of fossil origin. Examples of polymers include biodegradable polyesters, such as polylactic acid (PLA), poly hydroxy alkanoates (PHA), polybutylene adipate terephthalate (PBAT), polybutylene succinate (PBS), and starch blends. Additives and processing aids for manufacturing may be present in the polymeric starting composition, such as surfactants like Triton X-100, DDM, digitonin, Tween 20, Tween 80. Other additives include colourants, terpene resins, gum rosin, oils, vegetable waxes, chitin, lignin, wood flour and walnut shell flour.

Advantageously, if desired, the fibres in the web are thermally bonded to achieve a stable structure. A web made by laying fibres using air is a suitable example. Meltblown spinning with subsequent laying using air is preferred for manufacturing the web that is subsequently shaped into the plug.

The invention also provides a method of manufacturing a plant plug for germinating, cutting and/or growing plants as outlined above, comprising the steps of providing a polymeric composition,
forming a web having polymeric fibres from the polymeric composition, wherein the fibres are substantially oriented in the plane of the web, preferably in the longitudinal direction thereof, and optionally are locally mutually bonded to one another,
deriving a strip arranged in multiple vertically arranged layers from the web.

In the method according to the invention a polymeric composition as outlined above is prepared. Filaments are formed from the polymeric composition, e.g. using meltblown spinning with an appropriate die or spinneret. The filaments are formed into a web, e.g. an laying of filaments using air in a web, wherein the filaments are substantially oriented in the longitudinal direction of the web with a few if any, local bonds between the fibres. As explained above, the web may be arranged, e.g. wound or folded, directly in a plurality of layers, such that in the vertically arranged layers of the upright plant plug the filaments or fibres are oriented horizontally, or a strip may be cut from the web, which strip is arranged, e.g. wound or folded, in a plurality of vertically arranged layers, wherein the fibre orientation is either horizontally or vertically.

In the embodiment of a cylindric plant plug the strip or web is wound onto itself in multiple layers into a cylinder shape. The strip or web is rolled onto itself in multiple layers, e.g. with or without using a small diameter core such as one or more rotatable (metal) threads or a rod.

In the embodiment of a rectangular plug the strip or web is folded onto itself in a zigzag configuration in multiple layers, and typically the layered stack is turned vertically over 90°, such that the layers in the upright plant plug extend vertically.

The number of layers having a predetermined area weight is dependent from inter alia the desired plug dimensions, such as diameter and plug density, which themselves may be dictated by the type of seed, tissue culture broth or embryo, seedling, cutting or plant to be grown. Typically the strip or web has a width that covers a number of heights of the plant plug. In such a case the wound strip or web is cut into individual plant plugs having a predetermined height either before or after removal of the core. Similarly a stack of zigzagged layers produced from a broad strip or web can be dimensioned to the required height of the plant plug, such as by cutting.

As mentioned above, if desired the loose end of the outermost layer of the web may be bonded to the adjacent inner layer, e.g. in a local heat treatment.

Directly (in-line) preparing the polymeric composition and spinning the fibres into a web using an extruder is contemplated. However, the conditions in the extruder like temperature, pressure, and nozzle diameter are difficult to control in view of repeatability between batches. Therefore, in view of repeatability preparation of the composition and forming the fibres are preferably carried out in separated steps.

In an embodiment of the invention the method is performed in a decentralized manner. For example, the polymeric composition is prepared as a solid block and shipped to the user, such as a regional or local manufacturer or to the grower himself. According to his need, the user manufactures the plant plugs by (top) melting the composition and manufacturing the web, from which the plant plugs are formed. In this way, transportation costs are substantially reduced compared to shipping the plant plugs themselves, because the volume of the goods to be shipped is substantially smaller. Additionally, the risk of contamination of the plant plugs, e.g. with harmful micro-organism during transportation is reduced, which improves the sanitization and safety conditions and reduces the risk of the occurrence of (extraneous) diseases and infections of the plant plugs. Therefore sterilization at the grower may become superfluous. Moreover, the user such as the grower does not have to have an inventory of various plant plugs configured for cultivating a particular type of plants. Instead the invention allows to manufacture the type and number of plant plugs according to his needs at any moment. Top melting the solid block, wherein the block is melted gradually according to the required amount prevents degradation of the polymeric composition.

The details, properties and embodiments presented hereinabove with respect to the plant plug, web, strip and polymeric composition are similarly applicable to the method according to the invention. Preferred embodiments of the method according to the invention are also described herein.

The invention also relates to the use of a plant plug according to the invention and/or obtained by means of the manufacturing method according to the invention in agriculture, horticulture, hydroponic culture for germinating, cutting and/or growing plants, such as tissue culture and young plants production . . .

Furthermore the invention relates to an assembly of a tray, e.g. a seed tray, having a plurality of recesses, wherein a recess comprises a plant plug according to the invention and/or a plant plug obtained by the method according to the invention.

In another aspect the invention relates to an assembly of a gutter or floater in a greenhouse and a plurality of plant plugs according to the invention and/or plant plugs obtained by the method according to the invention.

### BRIEF DESCRIPTION OF THE DRAWINGS

The invention is further illustrated by means of the drawings, wherein:

FIG. 1 shows an embodiment of a plant plug according to the invention;

FIG. 2 shows a photograph of an embodiment of a plant plug according to the invention;

FIG. 3 shows a photograph of a detail of the embodiment of FIG. 2;

FIG. 4 shows an embodiment of a seed tray provided with plant plugs according to the invention;

FIG. 5 is a diagrammatic representation of an embodiment of a plant plug manufacturing process according to the invention; and

FIG. 6 is a diagrammatic representation of a part of another embodiment of a plant plug manufacturing process according to the invention.

### DETAILED DESCRIPTION OF THE INVENTION

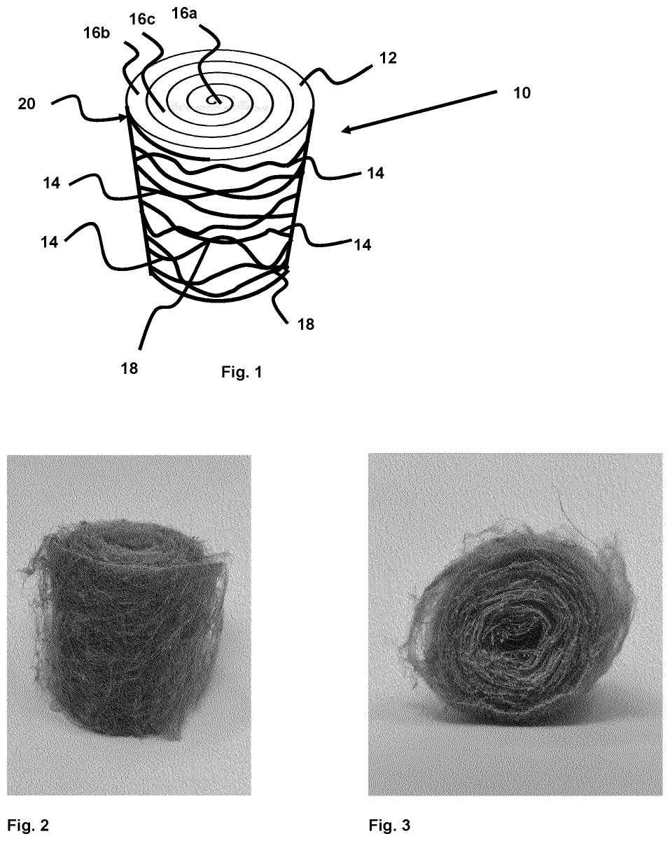

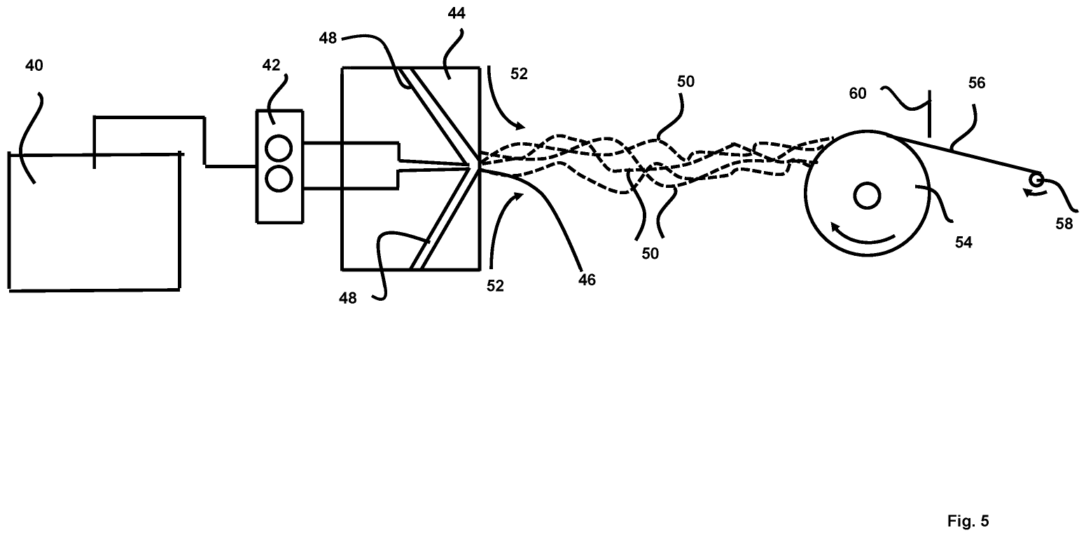

In FIG. 1 an embodiment of a plant plug according to the invention is shown diagrammatically. The plant plug is indicated in its entirety by reference numeral 10. The plant plug 10 has a generally cylindrical shape and is composed of a strip 12 of fibres 14, in particular made from a biodegradable polymeric composition. The main orientation of the fibres in the plane of the flat web 56 (see FIGS. 5 and 6), from which the strip 12 as the plug is shaped, is in the longitudinal direction thereof. The strip 12 is wound onto itself, such that there is a plurality of layers or windings 16, of which only a few are shown. In practicing the invention, the number of windings will be considerable to achieve the desired dimensions. In this embodiment of the plant plug the fibres 14 are circumferentially orientated as is shown from the inner most winding 16a to the outermost winding 16b, with a few bonds 18, if any, e.g. thermal bonds, between individual fibres 16. The layers 16 themselves are not bonded to one another. The fibres at the free end 20 of the outermost winding 16b may be bonded, e.g. thermally bonded, to the adjacent inner winding 16c. The dimensions of the plant plug 10 and density are typically dictated by the particular application, i.e. the type of seed, seedling, cutting or plant to be grown in the plant plug.

FIGS. 2 and 3 comprise photographs of an embodiment of a plant plug 10 according to the invention. FIG. 2 shows the embodiment in perspective view, while FIG. 3 is a top view.

Instead of horizontally oriented fibres the fibres in a layer may have a vertical orientation, when a strip, cut from the web, is wound onto itself in a direction cross to the fibre orientation in the web.

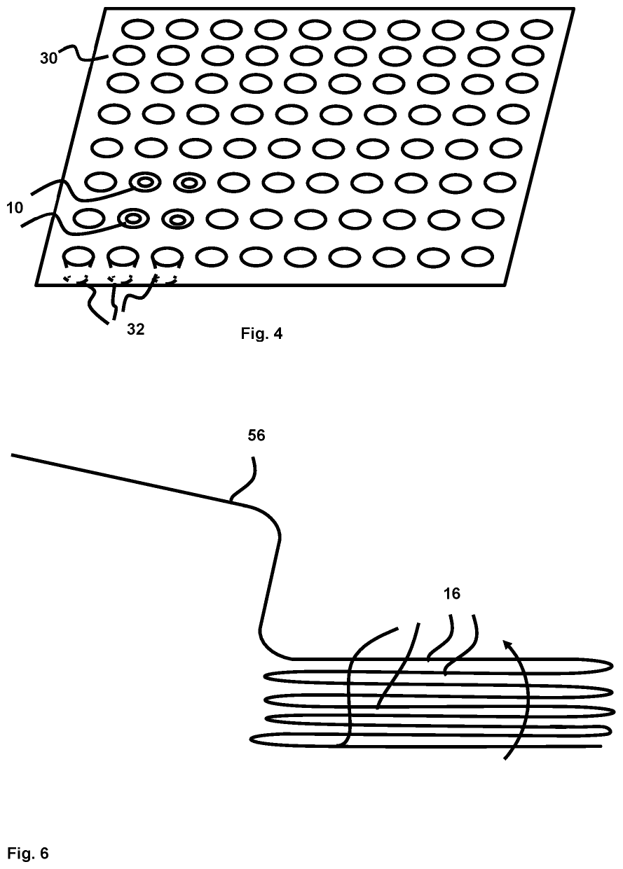

FIG. 4 is an embodiment of a seed tray 30 having a plurality of recesses 32 (some shown in the left hand side by dashed lines), wherein plant plugs 10 according to the invention are arranged (only a limited number of plant plugs 10 are shown). As in this embodiment the plant plug 10 according to the invention are dimensionally stable cylinders, they can also be used in culturing systems without being confined in recesses, e.g. in germinating. For example, the plant plugs 10 as such can be arranged in gutter systems and floater systems

FIG. 5 is a diagram of an embodiment of a decentralized manufacturing process according to the invention. A solid polymeric composition is prepared from the starting materials thereof. The composition in solid form is transported to the user, e.g. grower. At the user's location the solid composition is melted in a heated vessel 40, such as a top melt heater, wherein only the top of the solid composition is melted. The molten composition is fed by means of a (gear) pump 42 from the vessel 40 to a die 44 having a plurality of nozzles 46. Typically the die 44 comprises one or more horizontal rows of nozzles 46, which may also be staggered. In order to form the open web the nozzle density may be in the range of 2-10 nozzles/cm. The nozzle diameter is typically 10-100 micrometres. Simultaneously air is forced through air channels 48 coplanar to the nozzles 46. The composition is shaped into long filaments 50 that are heat conditioned by secondary air flows (indicated by arrows 52). Local random bonds between still partially molten filaments may occur during their flight of several metres The filaments 50 are collected on a rotating collector 54, from which a web 56 of the filaments laid using air 50 is drawn. In this embodiment the web 56 thus formed is directly rolled onto a rotatable core 58. Once the desired diameter is obtained, the web 56 is cut, e.g. using cutter 60, thereby obtaining the wound strip 12. The wound strip 12 is removed from the core 58. As typically the width of the web 56 is several times the height of a plant plug 10, the wound strip 12 is cut into individual plant plugs 10.

If desired, a strip may be cut from the web prior to winding. Subsequently the strip thus derived from the web is rolled onto itself in order to shape the plant plug therefrom, either in a direction parallel to the fibre orientation, or in a direction perpendicular to the fibre orientation.

Instead of winding on the core 58 as shown in FIG. 5 the web 56, derived from the collector 54, may be folded in a plurality of layers 16 as illustrated in FIG. 6. Once the desired total thickness of the stacked layers 16 is achieved, the web 56 is cut thereby obtaining a strip 12 of stacked layers 16. The stack is turned 90° as indicated by an arrow, such that the layers 16 extend in vertical direction and are configured in a zigzag pattern with the folds between adjacent layers also oriented in vertical direction. Usually the rectangular plant plug 10 thus obtained is used in combination with a tray having rectangular recesses.

If desired, a strip may be cut from the web prior to folding. Subsequently the strip thus derived from the web is folded onto itself in order to shape the plant plug therefrom either in a direction parallel to the fibre orientation either in a direction perpendicular to the fibre orientation. Thereafter the folded strip is turned 90°, such that the layers are arranged in vertical direction.

Use of the web as a plant plug in the shape of a multi-layered mat having a small overall height is also contemplated.

1.-28. (canceled)

29. A plant plug for germinating, cutting and/or growing plants and/or for tissue culture, comprising a strip of polymeric fibres or filaments, wherein the fibres are substantially oriented in the plane of the strip and optionally locally mutually bonded to one another, and wherein the strip is arranged in multiple, vertically arranged layers, wherein in the strip the fibres or filaments are substantially oriented in the longitudinal direction or the width direction thereof.

30. The plant plug according to claim 29 wherein in a layer the fibres are substantially oriented horizontally or vertically.

31. The plant plug according to claim 29, wherein the strip is wound onto itself in multiple layers into a cylinder shape.

32. The plant plug according to claim 29, wherein the strip is arranged in a zigzag configuration.

33. The plant plug according to claim 29, wherein the strip is derived from a web, wherein in the web the fibres are substantially oriented in the plane of the web, preferably in the longitudinal direction thereof, and optionally locally mutually bonded to one another.

34. The plant plug according to claim 29, wherein the strip is comprised of fibres laid using air.

35. The plant plug according to claim 29, wherein the plug is biodegradable.

36. The plant plug according to claim 29, wherein the fibres are prepared from a polymer composition comprising a biodegradable polymer, and optionally one or more additives.

37. A method of manufacturing a plant plug for germinating, cutting and/or growing plants, comprising the steps of
providing a polymeric composition;
forming a web having polymeric fibres from the polymeric composition, wherein the fibres are substantially oriented in the plane of the web, preferably in the longitudinal direction thereof, and optionally are locally mutually bonded to one another; and
deriving a strip arranged in multiple, vertically arranged layers from the web, wherein in a layer the fibres are substantially oriented horizontally or vertically.

38. The method according to claim 37, wherein the step of deriving the strip in multiple vertically arranged layers comprises winding the strip or the web onto itself in multiple layers into a cylinder shape.

39. The method according to claim 37, wherein the step of deriving the strip in multiple vertically arranged layers comprises folding the strip or the web in a zigzag configuration.

40. The method according to claim 37, further comprising connecting a free end of the outermost layer of the strip to an adjacent inner layer.

41. The method according to claim 37, further comprising a step of cutting the strip of multiple vertically arranged layers into a plant plug having a predetermined height.

42. The method according to claim 37, wherein the web forming step comprises meltblown spinning and laying of filaments using air.

43. The method according to claim 37, wherein the plug is biodegradable.

44. The method according to claim 43, wherein the polymeric composition comprises a biodegradable polymer, and optionally one or more additives.

45. The method according to claim 37, wherein the polymeric composition is provided as a solid, the solid polymeric composition is transported to a user location, where the polymeric composition is melted and extruded through the nozzles of a die to form the web.

46. A method comprising:
utilizing the a plant plug according to claim 29 in agriculture, horticulture, hydroponic culture for germinating, cutting and/or growing plants.

47. An assembly of a tray having a plurality of recesses, wherein a recess comprises a plant plug according to claim 29.

48. An assembly of a gutter or floater and a plurality of plant plugs according to claim 29.
